(19) United States
(12) Patent Application Publication
(10) Pub. No.: US 2022/0383736 A1
(43) Pub. Date: Dec. 1, 2022

(54) METHOD FOR ESTIMATING COVERAGE OF THE AREA OF TRAFFIC SCENARIOS

(71) Applicant: ZF Friedrichshafen AG, Friedrichshafen (DE)

(72) Inventors: Johannes DAUBE, Friedrichshafen (DE); Jochen KÖHLER, Dornbirn (AT); Mladjan RADIC, Langenargen (DE); Amir OMERADZIC, Bregenz (AT); Oliver SCHAUDT, Köln (DE); Julian KING, Rankweil (AT)

(73) Assignee: ZF Friedrichshafen AG, Friedrichshafen (DE)

(21) Appl. No.: 17/775,810

(22) PCT Filed: Nov. 6, 2020
(86) PCT No.: PCT/EP2020/081304

§ 371 Date: May 10, 2022

(30) Foreign Application Priority Data
Nov. 13, 2019 (DE) 10 2019 217 533.3

(51) Int. Cl. G08G 1/01; G06N 3/02

(52) U.S. Cl. CPC G08G 1/0133; G08G 1/0137; G08G 1/0116; G06N 3/02

(57) ABSTRACT

A computer-implemented method for estimating coverage of the field of traffic scenarios includes providing various traffic scenarios, classifying and/or clustering the traffic scenarios into known or unknown traffic scenarios, using a statistical process on the classified and/or clustered traffic scenarios for estimating predefined classification numbers that describe the coverage of the fields of traffic scenarios, and generating other traffic scenarios or termination of the method, depending on the classification numbers.

The invention relates to a method for estimating the coverage of the fields of traffic scenarios, and a computer program.

An autonomous vehicle is a vehicle that can detect its environment and navigate therein with very little or no user input. An autonomous vehicle detects its environment using sensor devices such as radar, lidar, imaging sensors, etc.

There are various stages or levels of automation: assisted, partially automated, highly automated, fully automated, and autonomous.

At level 1, assisted driving, the driver is supported by at least one modern assistance system, e.g. adaptive cruise control or a lane departure warning system.

At level 2, partially automated driving, two or more assistance systems are combined, e.g. a traffic congestion assistant, which aids in maintaining distance and lane centering in stop-and-go traffic.

At level 3, conditional automated driving, the vehicle is fully autonomous in some traffic situations, i.e. it can brake, steer, accelerate, and change lanes autonomously. This also works over longer distances or times. The route is nevertheless precisely predefined.

At level 4, highly automated driving, sometimes also referred to as fully automated, the driver can transfer driving to the control system for longer periods of time. There are certain limits, however. Highly automated driving can only take place in certain geographic areas and/or is limited to a low speed range, and/or only functions under certain weather conditions.

At level 5, autonomous driving, the vehicle assumes all driving functions. Unlike in levels 3 and 4, neither driving proficiency nor permission is needed—there is no need for a steering wheel, or brake and accelerator pedals.

Consequently, all of the people in the vehicle are passengers.

In comparison with level 2, partially automated driving, the testing for levels 4 and 5 is much more complex, as are the validation requirements. Levels 4 and 5 require a great deal of development, because there are numerous previously nonexistent traffic and testing scenarios that need to be taken into account in order for system to be viable for marketing. Covering all of the possible traffic scenarios with actual testing data is therefore not feasible for economic reasons.

For this reason, attempts have been made to obtain testing data from other sources, e.g. through simulations that reproduce the various traffic scenarios. It is not clear, however, which and how many traffic situations must be simulated.

The object of the invention is to create means with which it is possible to assess and/or estimate how many various traffic scenarios have already been documented in relation to all of the possible traffic scenarios.

This object is achieved with a computer-implemented method that has the features of claim 1 and an apparatus that has the features of claim 15.

Further advantageous measures are given in the dependent claims, which can be combined with one another in various ways to obtain further advantages.

The object is also achieved with a computer-implemented method for estimating the coverage for fields of traffic scenarios, comprising the following steps:
providing various traffic scenarios,
classifying and/or clustering the traffic scenarios into known or unknown traffic scenarios,
using a statistical process on the classified and/or clustered traffic scenarios for estimating predefined classification numbers that describe the coverage of the fields of traffic scenarios, and
generating other traffic scenarios or termination of the method, depending on the classification numbers.

The field of traffic scenarios is understood to be all of the traffic scenarios that have occurred in traffic.

A traffic scenario is understood to be a limited portion of all traffic situations. Unknown traffic scenarios are those traffic scenarios that have not yet been documented.

According to the invention, it has been realized that in testing and validating driving functions for vehicle operation at levels 4 or 5, the extent of all possible traffic scenarios is unknown. It has also been realized that it is not feasible to test or validate such vehicles with the classic driving tests from a technical or financial perspective, nor is there sufficient time for this. It has therefore been determined that the effort required for this validation must be reduced. This problem is solved by the invention.

First, there is a classification and/or clustering of the traffic scenarios that have been collected so far, which are then divided into known and unknown traffic scenarios. This classification and/or clustering makes it possible to estimate the coverage of the field of scenarios as well as to estimate the number of occurrences of future unknown traffic scenarios based on a statistical process. Classification numbers are defined for this in advance.

It is then possible to terminate the method based on the classification numbers; i.e. if unknown traffic scenarios occur at a “sufficiently” low frequency, this means that the scenario field has been sufficiently covered.

A statistical prognosis of the future occurrences of “unknown” traffic scenarios is therefore obtained through the method. The method also determines if a sufficiently precise scenario field coverage has been obtained.

The various traffic scenarios are preferably generated in simulations. A virtual simulation tool can generate a large number of traffic scenarios, and street and environmental conditions for this from virtual sensors. New traffic scenarios can then be generated from simulated disruptions of these traffic scenarios. These traffic scenarios are varied by a disrupting factor (e.g. a change in weather) in order to obtain new and additional traffic scenarios.

Alternatively or additionally, the various traffic scenarios are preferably generated from sensor data obtained from a stationary and/or mobile traffic detection system. A mobile traffic detection system can be the detection system in a test vehicle, for example. Multiple test vehicles can also be used for this. Alternatively, cell phone cameras, etc., can also be used. A stationary traffic detection system can be a traffic camera and/or traffic monitoring device, for example. These form a comprehensive and inexpensive source for collecting data.

The various traffic scenarios can also be generated, for example, using data-recording sources such as drones.

Other possible sources for collecting data are data base systems in which drivers are paid to drive real vehicles along certain routes in order to record traffic scenarios.

In another preferred embodiment, a clustering method is used for the classification.

The classifier is preferably a self-learning system based on artificial intelligence. The classifier can be a neural network, in particular in the form of a deep neural network. These are capable of processing large quantities of data.

A trained classifier is preferably used for the classification, in which the classifier is trained using distinguishing features. Possible distinguishing features comprise physical variables, e.g. position, orientation, speed, acceleration, and time, which describe the movement of objects in traffic in relation to one another.

An extrapolation process is preferably used for the statistical process. An extrapolation process makes a prediction regarding the undocumented field, taking the documented field into account, which comprises traffic scenarios in this case. As a result, this process is particularly good at predicting unknown traffic scenarios that will occur in the future on the basis of the classification/clustering.

A core density estimator can also be used in the statistical process. Core density estimators use processes for continuously estimating an unknown distribution. These core density estimators are known for being able to estimate not only a uniform distribution, but also a random distribution, and are therefore particularly suitable for predicting future occurrences of unknown traffic scenarios.

A Good-Toulmin estimator or an Efron-Thisted estimator, or variations thereof, can also be used for the statistical process. These estimators are used in ecology and are used to estimate the number of types that are represented in an ecosystem, and those which have not yet been seen in a sample. They relate in particular to how many new types will be discovered if more samples are taken from an ecosystem. These estimators can therefore be used in a clever manner to predict future occurrences of unknown traffic scenarios. The Good-Toulmin estimator and the Efron-Thisted estimator, or variations thereof, can be readily scaled and are therefore ideal for dealing with large quantities of data. Furthermore, they can be quickly calculated. The Good-Toulmin estimator and the Efron-Thisted estimator, as well as variations thereof, can therefore be feasibly and readily used for this purpose, and will deliver very good results under the boundary conditions specified herein.

In another preferred embodiment, the classification numbers comprise a number of unknown traffic scenarios and/or a statistical distribution of the unknown traffic scenarios. These classification numbers are particularly ideal for estimating the coverage of scenario fields. The predefined classification numbers contain information regarding the extent to which the previously documented scenario fields cover the field of all traffic scenarios. The number of unknown traffic scenarios estimated through the classification/clustering, and the statistical distribution of these unknown traffic scenarios can be taken into consideration in creating the classification numbers.

The classification numbers also comprise, for example, the criticality of the unknown traffic scenarios. The criticality relates to the danger of a traffic situation (critical traffic situation), in which intervention by a driver assistance system or a driver is necessary.

In particular, the classification numbers can be incorporated in the estimation in a weighted manner. As such, a higher criticality may be weighted more heavily than less critical unknown traffic scenarios.

New critical traffic scenarios are preferably simulated on the basis of the criticality of the unknown traffic situations. New critical traffic scenarios are also, or instead thereof, preferably simulated on the basis of the identified unknown traffic scenarios. This can take place, for example, by varying the identified critical or unknown traffic scenarios. One or more parameters of the identified critical traffic scenarios can be modified for this. Consequently, the already existing amount of traffic scenarios can be condensed in a targeted manner with new simulated critical traffic scenarios.

The already existing traffic scenarios can also be condensed in a targeted manner, based on the identified unknown traffic scenarios.

The traffic scenarios are preferably related to selected routes or a selected area. The method can consequently be terminated in a targeted manner more quickly. These traffic scenarios can be used, for example, for validating level 4 or 5 driving functions.

Furthermore, these traffic scenarios are preferably first clustered, and the clustered traffic scenarios are subsequently classified.

The object is also achieved by an apparatus for data processing, comprising a processor that is configured to execute the method described above.

Further features, properties and advantages of the present invention can be derived from the following description in reference to the attached drawings. Therein:

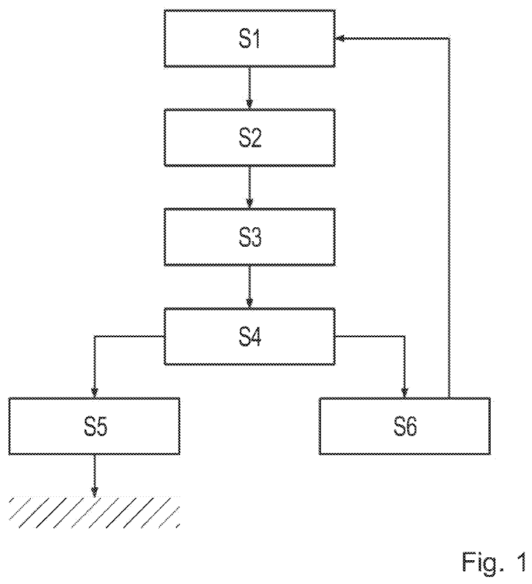

FIG. 1 shows, schematically, a first embodiment of the method according to the invention;

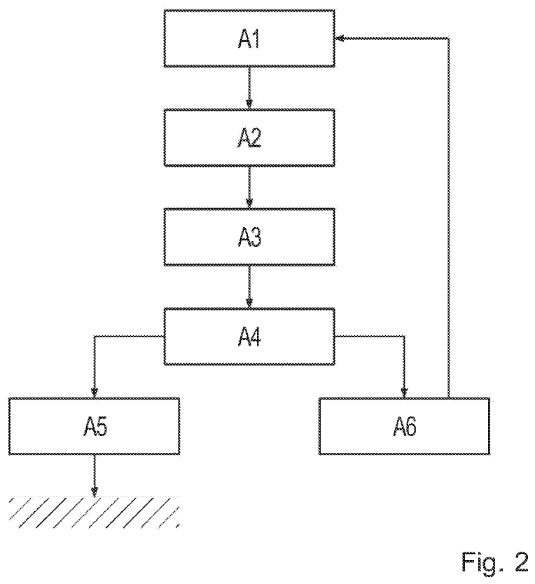

FIG. 2 shows, schematically, a second embodiment of the method according to the invention;

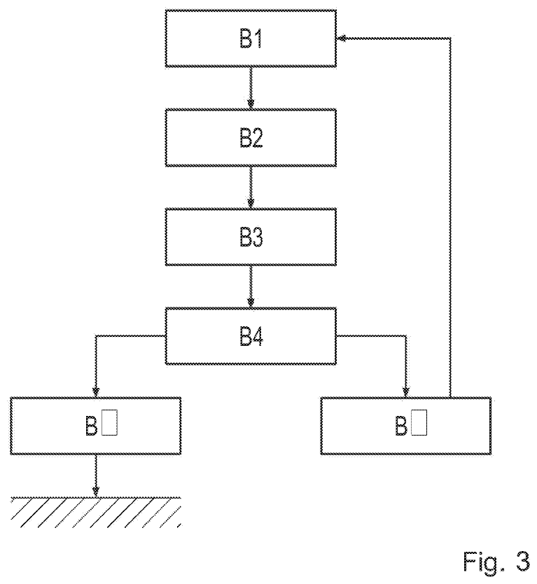

FIG. 3 shows, schematically, a third embodiment of the method according to the invention.

Numerous traffic scenarios are provided in a first step S1. These can be generated, for example, by recording real traffic scenarios with measurement systems in test vehicles, or through simulation. Real traffic scenarios can be modified in the simulations, for example, in order to generate new traffic scenarios. All of these traffic scenarios relate to routes, i.e. the scenarios all correspond to traffic scenarios in traffic. Alternatively or additionally, cell phone cameras, drones, etc. can be used for generating real traffic scenarios. It is also possible to generate real traffic scenarios with stationary and/or traffic recording systems, e.g. traffic cameras and/or traffic monitoring devices. These form a comprehensive and cost effective source for collecting data.

Other sources for collecting data could comprise a data base system in which drivers are paid to drive real vehicles along specific routes in order to record traffic scenarios.

In a second step S2 these traffic scenarios are clustered and classified as known or unknown traffic scenarios. The clustering can take place in a clustering process. The traffic scenarios can be classified as known or unknown traffic scenarios in the clustering process.

A statistical process is applied to the clustered traffic scenarios in a third step S3 to estimate predefined classification numbers that describe the approximate coverage of the scenario field. The predefined classification numbers contain information regarding the extent to which the previously documented scenario field covers the field of all traffic scenarios.

By way of example, the number of unknown traffic scenarios estimated through the clustering, the statistical distribution of the unknown traffic scenarios obtained in this manner, and the criticality of the unknown traffic scenarios determined in this manner can be taken into account in the classification numbers.

The criticality describes the danger posed by a traffic situation (critical traffic situation), in which intervention by a driver assistance system or a driver is necessary. An example of a critical traffic situation is when there is the danger of a collision between the vehicle and another vehicle or obstacle, or when the vehicle is too close to another vehicle or obstacle. Other critical traffic situations are also conceivable.

The classification numbers are estimated in a fourth step S4, and the method is either terminated or continued on the basis of the estimation. If the scenario field has not yet been sufficiently covered, for example, then further traffic scenarios must be generated. If, however, unknown traffic scenarios are “sufficiently” infrequent, then the scenario field has been sufficiently covered, and the method can be terminated. A sufficient coverage can be determined on an individual basis in this case, e.g. by the manufacturer.

The method is terminated in a fifth step S5 on the basis of the estimation. In this case, sufficient coverage of the scenario field has been obtained, and the method can be terminated.

In a sixth step S6, the scenario field coverage is still insufficient, and new traffic scenarios must be generated on the basis of the identified critical and/or unknown traffic scenarios.

This can take place, for example, by varying the identified critical and/or unknown traffic scenarios. One or more parameters of the identified critical and/or unknown traffic scenarios can be modified for this. By way of example, a critical, previously unknown traffic scenario can be a maneuver with numerous vehicles in a roundabout in which the test vehicle, which generates the sensor data, passes through the roundabout at a speed of 20 kmh. Traffic scenarios can then be simulated, for example, in which the test vehicle passes through the traffic circle at a speed of 50 kmh. Other parameters, such as weather conditions, e.g. rain, snow or fog, can also be modified. The method is then repeated using the newly generated traffic scenarios.

A statistical prognosis for the future occurrences of “unknown” traffic scenarios can be estimated using the method.

If the scenario field has been sufficiently covered, a virtual test vehicle can then make a virtual test drive of the traffic scenarios in the scenario field.

FIG. 2 shows a second embodiment of the method according to the invention. Numerous traffic scenarios are again provided in a first step A1 therein. These traffic scenarios relate to all routes, i.e. the scenario field corresponds to all traffic scenarios in traffic.

These traffic scenarios are classified by a trained classifier in a second step A2, and divided into known and unknown traffic scenarios. The classifier is a classifier that has been trained to identify distinguishing features. Possible distinguishing features comprise physical variables (position, orientation, speed, acceleration, and time), which describe the movement of objects in traffic in relation to one another.

A statistical process is applied in a third step A3 to the classified traffic scenarios to estimate the predefined classification numbers with respect to the scenario field coverage. The predefined classification numbers indicate the extent to which the previously documented scenario field covers the field of all traffic scenarios. An extrapolation process can be used for the statistical process. Alternatively, a core density estimator can be used. A Good-Toulmin estimator or Efron-Thisted estimator, or variations thereof, can also be used for the statistical process.

The classification numbers are estimated in a fourth step A4, and the method is either terminated or continued, based on this estimation.

Sufficient scenario field coverage is recognized in a fifth step A5, and the method is consequently terminated.

There is still insufficient scenario field coverage in a sixth step A6, and new traffic scenarios must be generated on the basis of identified critical and/or unknown traffic scenarios. The method is then repeated using the newly generated traffic scenarios.

FIG. 3 shows a third embodiment of the invention.

Numerous traffic scenarios are again provided in a first step B1. These traffic scenarios preferably relate to selected routes or a specific, previously selected area.

These traffic scenarios are first clustered in a second step B2, e.g. with a density-based clustering process. The clusters are subsequently classified with a trained classifier, and divided into known or unknown traffic scenarios. The classifier is a classifier that has been trained to identify distinguishing features. Possible distinguishing features comprise physical variables (position, orientation, speed, acceleration, and time), which describe the movement of objects in traffic in relation to one another.

A statistical process is applied in a third step B3, e.g. an extrapolation process, to the classified traffic scenarios in order to estimate predefined classification numbers that describe the coverage of the scenario field.

The classification numbers are then evaluated in a fourth step B4.

A sufficient scenario field coverage is identified in a fifth step B5, and the method is consequently terminated.

New traffic scenarios are generated in a sixth step B6 on the basis of identified critical and/or unknown traffic scenarios.

This can take place, e.g. by varying the identified critical and/or unknown traffic scenarios. One or more parameters of the identified critical traffic scenarios can be modified for this. The method is then repeated with the newly generated traffic scenarios.

### REFERENCE SYMBOLS

S1-S6 method steps

A1-A6 method steps

B1-B6 method steps

1. A computer-implemented method for estimating coverage of the field of traffic scenarios, the method comprising:
providing various traffic scenarios;
at least one of classifying or clustering the traffic scenarios into one of at least known or unknown traffic scenarios;
using a statistical process on the at least one of the classified or the clustered traffic scenarios for estimating predefined classification numbers that describe coverage of fields of the traffic scenarios; and
at least one of generating other traffic scenarios or terminating the method, depending on the classification numbers.

2. The computer-implemented method according to claim 1, further comprising generating the various traffic scenarios using a simulation.

3. The computer-implemented method according to claim 1, further comprising generating the various traffic scenarios from sensor data recorded by at least one of stationary or mobile traffic detection systems.

4. The computer-implemented method according to claim 1, further comprising using a clustering process to classify the traffic scenarios.

5. The computer-implemented method according to claim 1, further comprising using a self-learning system comprising artificial intelligence to classify the traffic scenarios.

6. The computer-implemented method according to claim 5, classifying the traffic scenarios by a trained classifier, wherein the trained classifier is trained to identify distinguishing features.

7. The computer-implemented method according to claim 6, wherein the trained classifier is a deep neural network.

8. The computer-implemented method according to claim 1, further comprising using at least one of an extrapolation process or a core density estimator for the statistical process.

9. The computer-implemented method according to claim 1, further comprising using at least one of a Good-Toulmin estimator or an Efron-Thisted estimator for the statistical process.

10. The computer-implemented method according to claim 1, wherein the classification numbers comprise at least one of a number of unknown traffic scenarios or a statistical distribution of the unknown traffic scenarios.

11. The computer-implemented method according to claim 1, wherein the classification numbers comprise a criticality of the unknown traffic scenarios.

12. The computer-implemented method according to claim 11, further comprising simulating new critical traffic scenarios on a basis of a criticality of the unknown traffic scenarios.

13. The computer-implemented method according to claim 1, further comprising simulating new traffic scenarios on a basis of the identified unknown traffic scenarios.

14. The computer-implemented method according to claim 1, further comprising:
clustering the traffic scenarios; and
subsequently classifying the clustered traffic scenarios.

15. An apparatus for data processing, comprising a processor that is configured to:
provide various traffic scenarios;
at least one of classify or cluster the traffic scenarios into one of at least known or unknown traffic scenarios;
use a statistical process on the at least one of the classified or the clustered traffic scenarios for estimating predefined classification numbers that describe coverage of fields of the traffic scenarios; and
at least one of generate other traffic scenarios or terminate a process, depending on the classification numbers.

16. The apparatus according to claim 15, wherein the processor is further configured to:
generate the various traffic scenarios using a simulation.

17. The apparatus according to claim 15, wherein the processor is further configured to:
generate the various traffic scenarios from sensor data recorded by at least one of stationary or mobile traffic detection systems.

18. The apparatus according to claim 15, wherein the processor is further configured to:
use a clustering process to classify the traffic scenarios.

19. The apparatus according to claim 15, wherein the processor is further configured to:
use a self-learning system comprising artificial intelligence to classify the traffic scenarios.

20. The apparatus according to claim 15, wherein the processor is further configured to:
use at least one of an extrapolation process or a core density estimator for the statistical process.
